(19) United States
(12) Patent Application Publication
(10) Pub. No.: US 2026/0219236 A1
(43) Pub. Date: Jul. 30, 2026

(54) REFERENCE STANDARD FOR EVALUATION OF A NON-DESTRUCTIVE INSPECTION DEVICE AND ASSOCIATED SYSTEM AND METHOD

(71) Applicant: The Boeing Company, Arlington, VA (US)

(72) Inventors: Zachariah Benedict, O'Fallon, MO (US); Adam Justusson, St. Charles, MO (US)

(21) Appl. No.: 19/036,870

(22) Filed: Jan. 24, 2025

(51) Int. Cl. G01N 29/22; G01N 29/04; G01N 29/26

(52) U.S. Cl. CPC G01N 29/225; G01N 29/04; G01N 29/26

(57) ABSTRACT

Disclosed herein is a reference standard for evaluation of a non-destructive inspection (NDI) device and associated system and method. The reference standard includes an elongated tool with an outer surface having an outer inspection surface defining a constant radius and an outer testing surface contiguous with the outer inspection surface. The reference standard incorporates various features designed to evaluate different performance parameters of the NDI system into a single device. The features may include a plurality of alignment mark, first inset parallel surfaces, a pair of parallel inspection lines, an angled distortion line, a plurality of radial index marks, and a plurality of lateral index marks.

### FIELD

This disclosure relates generally to evaluating non-destructive inspection (NDI) systems and more particularly to a reference standard for evaluating NDI systems.

### BACKGROUND

Non-destructive inspection (NDI) is widely used across industries, such as aerospace, automotive, and manufacturing, to evaluate the integrity of materials and components without causing damage. NDI systems, including ultrasonic NDI systems, rely on precise calibration and validation to ensure accurate defect detection, alignment, and measurement capabilities. Common methods for establishing NDI system performance often rely on multiple reference standards, each designed to evaluate specific performance metrics, such as alignment, distortion, radial index, or defect detection. These reference standards are typically bespoke, requiring custom designs to address individual system performance features. Additionally, the fabrication of such standards often involves expensive materials and specialized manufacturing processes, which are both time-consuming and costly. Moreover, when different scanning configurations or operational parameters are used, existing standards may require significant modifications to accommodate variations, further adding to the cost and timeline.

### SUMMARY

The subject matter of the present application has been developed in response to the present state of the art, and in particular, in response to the shortcomings in the evaluation of NDI systems, that have not yet been fully solved by currently available techniques. Accordingly, the subject matter of the present application has been developed to provide a reference standard and associated system and method that overcome at least some of the above-mentioned shortcomings of prior art techniques.

The following is a non-exhaustive list of examples, which may or may not be claimed, of the subject matter, disclosed herein.

Disclosed herein is a reference standard for evaluation of a non-destructive inspection (NDI) device. The reference standard includes an elongated tool having a first end, a second end, and an outer surface extending between the first end and the second end. The outer surface includes an outer inspection surface defining a constant radius and an outer testing surface forming a remainder of the outer surface contiguous with the outer inspection surface. The reference standard include various features including a plurality of alignment marks positioned on the outer inspection surface adjacent to the first end of the elongated tool, first inset parallel surfaces inset relative to the outer testing surface, the first inset parallel surfaces extending from the first end towards the second end of the elongated tool and having a first length, a pair of parallel inspection lines extending longitudinally along the outer testing surface and positioned within an inspection arc defined along a circumference of the outer testing surface, an angled distortion line extending between and intersecting the pair of parallel inspection lines at an angle relative to the pair of parallel inspection lines, a plurality of radial index marks arranged circumferentially about and extending longitudinally along the outer testing surface, the plurality of radial index marks being parallel to each other and equally spaced apart, and a plurality of lateral index marks arranged axially along the outer testing surface and extending laterally across the outer testing surface, the plurality of lateral index marks being parallel to each other and equally spaced apart. The preceding subject matter of this paragraph characterizes example 1 of the present disclosure.

The reference standard includes second inset parallel surfaces, inset relative to the outer testing surface, the second inset parallel surfaces extending from the second end towards the first end of the elongated tool along a second length. The preceding subject matter of this paragraph characterizes example 2 of the present disclosure, wherein example 2 also includes the subject matter according to example 1, above.

The outer testing surface includes a normalization area that is free of known defects and extends longitudinally along only a portion of the outer testing surface. The preceding subject matter of this paragraph characterizes example 3 of the present disclosure, wherein example 3 also includes the subject matter according to any of examples 1-2, above.

The reference standard includes a plurality of inspection holes formed in the outer testing surface, the plurality of inspection holes including at least one proximal hole , at least one mid hole, and at least one distal hole. The at least one proximal hole has a first depth relative to the outer testing surface. The at least one mid hole has a second depth relative to the outer testing surface. The second depth is greater than the first depth. The at least one distal hole has a third depth relative to the outer testing surface. The third depth is greater than the second depth. The preceding subject matter of this paragraph characterizes example 4 of the present disclosure, wherein example 4 also includes the subject matter according to any of examples 1-3, above.

The first depth of the at least one proximal hole is at least 0.010 inches. The third depth of the at least one distal hole is at most 1.0 inches. The second depth of the at least one mid hole is more than the first depth and less than the third depth. The preceding subject matter of this paragraph characterizes example 5 of the present disclosure, wherein example 5 also includes the subject matter according to example 4, above.

The plurality of inspection holes includes at least three proximal holes, at least three mid holes, and at least three distal holes. The at least three proximal holes include a first proximal hole positioned along a first plane that is parallel to a central axis of the elongated tool, a second proximal hole positioned along a second plane parallel to the first plane, and a third proximal hole positioned along a third plane parallel to the first plane. The second plane is interposed between the first plane and the third plane. The at least three mid holes include a first mid hole positioned along the first plane, a second mid hole positioned along the second plane, and a third mid hole positioned along the third plane. The at least three distal holes include a first distal hole positioned along the first plane, a second distal hole positioned along the second plane, and a third distal hole positioned along the third plane. The preceding subject matter of this paragraph characterizes example 6 of the present disclosure, wherein example 6 also includes the subject matter according to example 4, above.

The reference standard includes a ramped area formed in the outer testing surface, the ramped area having a radius of curvature that transitions from a first radius to a second radius over a predetermined span along the length of the elongated tool. The preceding subject matter of this paragraph characterizes example 7 of the present disclosure, wherein example 7 also includes the subject matter according to any of examples 1-6, above.

The reference standard includes a runout area formed in the outer testing surface contiguous with the ramped area. The runout area has a constant radius equal to the second radius of the ramped area and extending along a length of the outer testing surface. The preceding subject matter of this paragraph characterizes example 8 of the present disclosure, wherein example 8 also includes the subject matter according to example 7, above.

The plurality of alignment marks includes a first alignment mark positioned at a central reference location, a second alignment mark positioned at an angle of -45 degrees relative to the first alignment mark along a circumference of the outer inspection surface, and a third alignment mark positioned at an angle of +45 degrees relative to the first alignment mark along a circumference of the outer inspection surface. The preceding subject matter of this paragraph characterizes example 9 of the present disclosure, wherein example 9 also includes the subject matter according to any of examples 1-8, above.

The plurality of radial index marks includes at least four radial index marks. The preceding subject matter of this paragraph characterizes example 10 of the present disclosure, wherein example 10 also includes the subject matter according to any of examples 1-9, above.

The plurality of lateral index marks includes at least four lateral index marks. The preceding subject matter of this paragraph characterizes example 11 of the present disclosure, wherein example 11 also includes the subject matter according to any of examples 1-10, above.

The constant radius of the outer inspection surface is between, and inclusive of, 0.25 inches and 4.0 inches. The preceding subject matter of this paragraph characterizes example 12 of the present disclosure, wherein example 12 also includes the subject matter according to any of examples 1-11, above.

The elongated tool is made of a homogeneous material. The preceding subject matter of this paragraph characterizes example 13 of the present disclosure, wherein example 13 also includes the subject matter according to any of examples 1-12, above.

The elongated tool is made of an acrylic material. The preceding subject matter of this paragraph characterizes example 14 of the present disclosure, wherein example 14 also includes the subject matter according to any of examples 1-13, above.

Further disclosed herein is a non-destructive inspection (NDI) system for evaluating components. The NDI system includes an NDI device and a reference standard. The NDI device includes a probe configured to interact with a reference standard and a control system operatively connected to the probe. The control system is configured to analyze data collected during a scanning operation between the probe and the reference standard. The reference standard includes an elongated tool having a first end, a second end, and an outer surface extending between the first end and the second end. The outer surface includes an outer inspection surface defining a constant radius and an outer testing surface forming a remainder of the outer surface contiguous with the outer inspection surface. The reference standard further includes various features including a plurality of alignment marks positioned on the outer inspection surface adjacent to the first end of the elongated tool, first inset parallel surfaces inset relative to the outer testing surface, the first inset parallel surfaces extending from the first end towards the second end of the elongated tool and having a first length, a pair of parallel inspection lines extending longitudinally along the outer testing surface and positioned within an inspection arc defined along a circumference of the outer testing surface, an angled distortion line extending between and intersecting the pair of parallel inspection lines at an angle relative to the pair of parallel inspection lines, a plurality of radial index marks arranged circumferentially about and extending longitudinally along the outer testing surface, the plurality of radial index marks being parallel to each other and equally spaced apart, and a plurality of lateral index marks arranged axially along the outer testing surface and extending laterally across the outer testing surface, the plurality of lateral index marks being parallel to each other and equally spaced apart. The preceding subject matter of this paragraph characterizes example 15 of the present disclosure.

Further disclosed herein is a method for evaluating an NDI system using a reference standard. The method includes scanning a probe of an NDI device along an outer inspection surface of an elongated tool. The method also includes verifying alignment of the probe using a plurality of alignment marks positioned adjacent to a first end of the elongated tool. The method further includes assessing horizontal linearity of the NDI device using first inset parallel surfaces, inset relative to an outer testing surface of the elongated tool. The method additionally includes evaluating arc coverage of the NDI device using a pair of parallel inspection lines extending longitudinally along the outer testing surface and positioned within an inspection arc defined along a circumference of the outer testing surface. The method also includes detecting distortion in scan data of the NDI device using an angled distortion line extending between and intersecting the pair of parallel inspection lines at an angle relative to the pair of parallel inspection lines. The method further includes verifying radial indexing spatial resolution of the NDI device using a plurality of radial index marks arranged circumferentially about and extending longitudinally along the outer testing surface. Additionally, the method includes verifying axial index spatial resolution of the NDI device using a plurality of lateral index marks arranged axially along the outer testing surface and extending laterally across the outer testing surface. The preceding subject matter of this paragraph characterizes example 16 of the present disclosure.

The method includes verifying array normalization of the NDI device and detecting dead elements within the probe using a normalization area that is free of known defects and extends longitudinally along only a portion of the outer testing surface. The preceding subject matter of this paragraph characterizes example 17 of the present disclosure, wherein example 17 also includes the subject matter according to example 16, above.

The method includes verifying a capacity of the NDI device to detect and determine a size of defects using a plurality of inspection holes formed in the outer testing surface of the elongated tool. Each one of the plurality of inspection holes has a specified depth relative to the outer testing surface. The preceding subject matter of this paragraph characterizes example 18 of the present disclosure, wherein example 18 also includes the subject matter according to any of examples 16-17, above.

The method includes verifying alignment of the NDI device relative to the outer testing surface of the elongated tool using a ramped area formed in the outer testing surface of the elongated tool. The ramped area transitions from a first radius to a second radius over a predetermined span along a length of the elongated tool. The preceding subject matter of this paragraph characterizes example 19 of the present disclosure, wherein example 19 also includes the subject matter according to any of examples 16-18, above.

The method includes fixing the reference standard relative to the probe during a scanning operation by engaging the first inset parallel surfaces and second inset parallel surfaces, positioned within the outer testing surface of the elongated tool, using a clamping device. The preceding subject matter of this paragraph characterizes example 20 of the present disclosure, wherein example 20 also includes the subject matter according to any of examples 16-19, above.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings, which are not necessarily drawn to scale, depict only certain examples of the subject matter and are not therefore to be considered to be limiting of its scope, the subject matter will be described and explained with additional specificity and detail through the use of the drawings, in which:

FIG. 1A is a schematic perspective view of one example of a reference standard including an elongated tool having an outer inspection surface with a first radius, and where the elongated tool has various features, according to one or more examples of the present disclosure;

FIG. 1B is a schematic side view of the reference standard of FIG. 1A, with the various features shown along a length of an outer testing surface of the reference standard, according to one or more examples of the present disclosure;

FIG. 2A is a schematic perspective view of another example of a reference standard including an elongated tool having an outer inspection surface with a second radius, and where the elongated tool has various features, according to one or more examples of the present disclosure;

FIG. 2B is a schematic side view of the reference standard of FIG. 2A, with the various features shown along a length of an outer testing surface of the reference standard, according to one or more examples of the present disclosure;

FIG. 3A is a schematic end view of the reference standard of FIG. 1A, illustrating an outer inspection surface, alignment marks, and inset parallel surfaces of the elongated tool, according to one or more examples of the present disclosure;

FIG. 3B is a schematic perspective partial view of the reference standard of FIG. 1A, illustrating the outer inspection surface, alignment marks, and inset parallel surfaces of the elongated tool, according to one or more examples of the present disclosure;

FIG. 3C is a schematic end view of the reference standard of FIG. 2A, illustrating an outer inspection surface, alignment marks, and inset parallel surfaces of the elongated tool, according to one or more examples of the present disclosure;

FIG. 3D is a schematic perspective view of a part of the reference standard of FIG. 2A, illustrating the outer inspection surface, alignment marks, and inset parallel surfaces of the elongated tool, according to one or more examples of the present disclosure;

FIG. 4 is a schematic top view of a part of one example of a reference standard, illustrating a normalization area of the elongated tool of the reference standard, according to one or more examples of the present disclosure;

FIG. 5 is a schematic bottom view of a part of one example of a reference standard, illustrating a pair of parallel inspection lines, an angled distortion line, a plurality of radial index marks, and a plurality of lateral index marks of the elongated tool, according to one or more examples of the present disclosure;

FIG. 6A is a schematic bottom view of a part of one example of a reference standard, illustrating a plurality of inspection holes formed in the outer testing surface of the elongated tool, according to one or more examples of the present disclosure;

FIG. 6B is a schematic perspective view of the reference standard of FIG. 6A, illustrating the plurality of inspection holes formed in the outer testing surface, according to one or more examples of the present disclosure;

FIG. 6C is a schematic cross sectional view of the reference standard of FIG. 6A taken along second plane 138, illustrating a depth of each one of the plurality of inspection holes, according to one or more examples of the present disclosure;

FIG. 7 is a schematic side view of a part of one example of a reference standard, illustrating a ramped area transitioning between a first radius and a second radius along a predetermined span along a length of the elongated tool, according to one or more examples of the present disclosure;

FIG. 8 is a schematic view of a non-destructive inspection (NDI) system, including an NDI device, a probe, and one example of a reference standard, according to one or more examples of the present disclosure; and

FIG. 9 is a schematic flow diagram of a method of evaluating a non-destructive inspection (NDI) device using a reference standard, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

Disclosed herein is a reference standard for evaluation of ultrasonic non-destructive inspection (NDI) systems, particularly for assessing radii quality on components. A reference standard, as used herein, refers to a physical tool or object incorporating known geometric or material characteristics, where serves as a baseline for assessing the accuracy, calibration, and performance of inspection equipment. The reference standard is designed to consolidate multiple test features into a single elongated tool, significantly reducing the need for multiple standards. By incorporating precisely machined test patterns, the reference standard enables the qualification of key performance metrics for NDI systems, including but not limited to: defect detection capability, inspection arc coverage, system linearity, identification of image distortion, and general system setup and alignment parameters. This integration allows for comprehensive evaluation of NDI systems with fewer setup changes, streamlining the inspection process and reducing logistical complexity.

The reference standard includes an elongated tool with an outer inspection surface and an outer testing surface. The outer inspection surface provides a constant radius and is configured for direct interaction with an ultrasonic probe. The outer testing surface, contiguous with the outer inspection surface, includes various test features arranged to allow performance assessment across multiple metrics. The reference standard allows for broad applicability to various inspection methods and transducer configurations for example, through-transmission ultrasound (TTU) , pulse-echo testing, (PE), and phased-array or single-element transducers.

Additionally, the reference standard can be reproduced at various sizes to accommodate different component geometries, including variations in part thickness, inner and outer radii, and probe-specific radii. This capability reduces lead time and lowers costs by eliminating the need for multiple individual standards, each tailored to a specific use case. That is, compared to conventional reference standards, which are generally bespoke and costly to manufacture, the design of the reference standard simplifies the process of producing tailored versions for varying inspection scenarios, minimizing overall cost and time investments. Furthermore, unlike conventional reference standards, which are often made of the same material as the components they represent, the reference standard can be produced using lower-cost materials, such as acrylic or aluminum, without comprising the evaluation of system performance parameters. This flexibility reduces manufacturing costs while maintaining the necessary performance characteristics offering a cost-effective alternative to conventional designs.

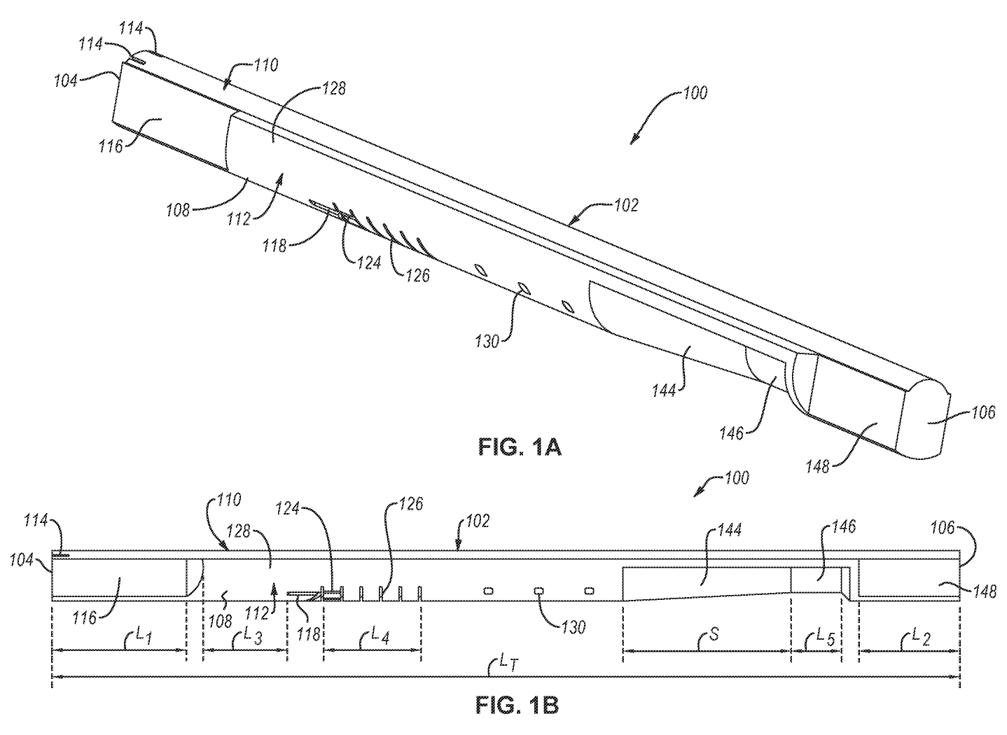

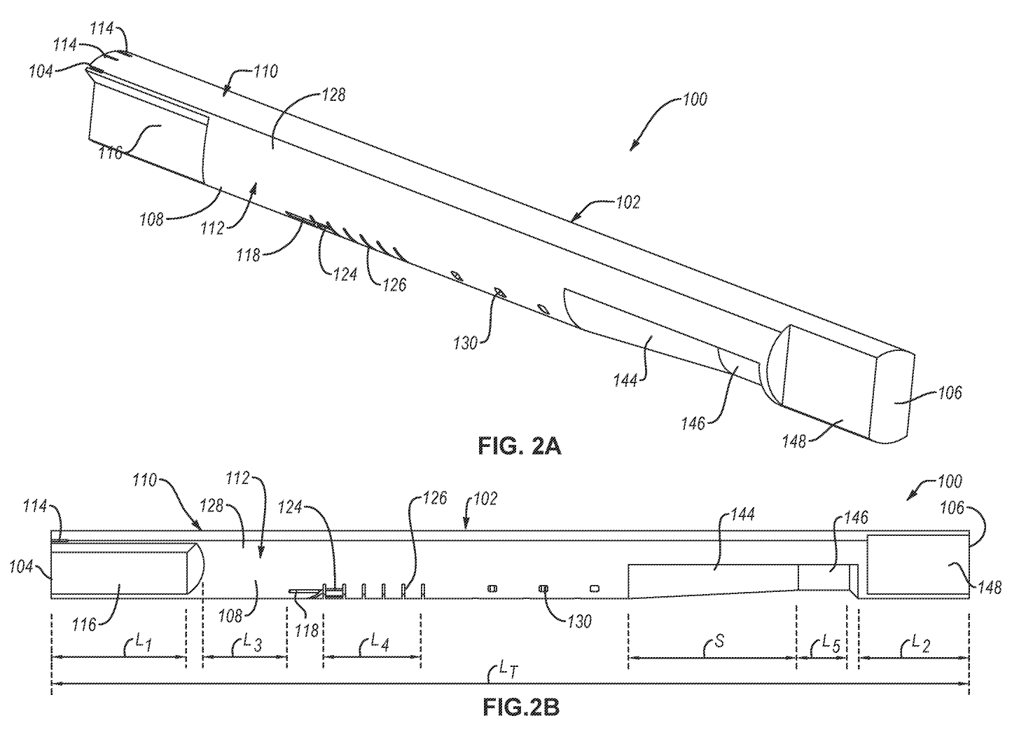

According to some examples, differently-sized reference standards are shown in FIGS. 1A-1B and 2A-2B. The reference standard 100 is configured for evaluating NDI systems, such as ultrasonic NDI systems, to assess various system performance metrics. As used herein, “evaluate” refers to the process of assessing the performance, accuracy and/or capabilities of the NDI system, including the ability of the NDI system to detect defects, measure geometric features, and ensure proper alignment and calibration. As further explained below, FIGS. 1A and 1B illustrate a reference standard 100 with an outer testing surface 112 that has a baseline radius larger than the constant radius (R) of the outer inspection surface 110. In contrast, FIGS. 2A and 2B illustrate a reference standard 100 where a baseline radius of the outer testing surface 112 is the same as the constant radius (R) of the outer inspection surface 110. Both variations of the reference standard 100 include the same features along a length (L_{T}) of the elongated tool 102.

The reference standard 100 includes an elongated tool 102 having a first end 104, a second end 106, and an outer surface 108 extending between the first end 104 and the second end 106. Note that the labels for the first end 104 and second end 106 are provided solely for convenience in identifying and describing the reference standard 100. These labels do not impose any specific order or direction of use, as the reference standard 100 can be utilized or referenced starting from either end. The elongated tool 102 has a length (L_{T}). In some examples, the length (L_{T}) is between, and inclusive of, 12 inches and 36 inches, such as between, and inclusive of, 18 inches and 30 inches. In certain cases, the length (L_{T}) is approximately 27 inches. Generally, the length (L_{T}) can be any length necessary to accommodate all of the features arranged along the elongated tool 102. The features on the reference standard 100 can be arranged in any order along the length (L_{T}) of the elongated tool 102, relative to the first end 104, and the specific arrangement shown is merely exemplary.

The reference standard 100 is made of a homogeneous material (i.e., consistent composition), ensuring uniformity in physical and mechanical properties across the length (L_{T}) of the elongated tool 102. The use of a homogeneous material is important to maintain consistent performance during NDI evaluations, as variations in material composition could introduce inaccuracies in defect detection or calibration results. The reference standard 100 may be made of any of various materials, including but not limited to, polymers, metals, composites, or other engineered materials. In some examples, the reference standard 100 is made of an acrylic material, which may reduce manufacturing costs while maintaining the necessary durability and precision necessary for evaluating NDI systems. In other examples, the reference standard 100 is made of a metal material, such as aluminum or stainless steel. The reference standard 100 may be manufactured through machining, casting, or additive manufacturing processes, depending on the material of the reference standard 100.

The outer surface 108 of the elongated tool 102 includes an outer inspection surface 110 and an outer testing surface 112. The outer inspection surface 110 defines a constant radius (R) (i.e., uniform and unvarying), and is configured to interact with a probe of an NDI system during scanning operations. As used herein, a “probe” refers to a device or instrument used in NDI systems to transmit and/or receive signals (e.g., ultrasonic, electromagnetic) for the purposes of evaluating material properties, detecting defects, or measuring geometric features of a component. In the context of the reference standard 100, scanning operations involve the interaction between the probe and the outer inspection surface 110 to evaluate the NDI system. In some examples, the constant radius (R) of the outer inspection surface 110 is between, and inclusive of, 0.25 inches and 4.0 inches, such as between, and inclusive of, 0.5 inches and 2.0 inches. For example, the constant radius (R) may be 0.5 inches, as shown in FIGS. 1A and 1B. In other examples, as shown in FIGS. 2A and 2B, the constant radius (R) may be 1.0 inches. The reference standards 100 illustrated in FIGS. 1A-2B are exemplary, and reference standards with other constant radii may be fabricated to suit specific inspection needs. For instance, selecting a particular radius for the outer inspection surface 110 may depend on the curvature of the components being inspected or the configuration of the probe to ensure effective contact and accurate data acquisition during scanning operations.

The outer testing surface 112, forms the remainder of the outer surface 108 and is contiguous with the outer inspection surface 110. The outer testing surface 112 includes various features for evaluating different performance characteristics of the NDI system. The outer testing surface 112, while not maintaining a constant radius, is derived from a uniform cylindrical geometry. This provides a baseline radius that is altered to incorporate the various features of the reference standard 100. In some examples, as shown in FIGS. 1A and 1B, the outer testing surface has a baseline radius that is larger than the constant radius (R) of the outer inspection surface. This configuration may provide a stepped transition or noticeable contour difference between the outer inspection surface 110 and the outer testing surface 112. For example, the baseline radius of the outer testing surface 112 may be 1.0 inches while the constant radius of the outer inspection surface 110 may be 0.5 inches. In other examples, as shown in FIGS. 2A and 2B, the outer testing surface has a baseline radius that is the same as the constant radius (R) of the outer inspection surface, resulting in a uniform cylindrical profile across portions of the reference standard 100.

The reference standard 100 includes various features along the length (L_{T}) of the elongated tool 102, where each feature is configured to evaluate specific performance metrics of an NDI system. Although a specific arrangement of features is shown, the reference standard 100 may be configured with more or fewer features to suit particular inspection needs. For clarity, the features are described as shown on the reference standard in FIGS. 1A-2B, though it is understood that not all reference standards will have the same arrangement or combination of features.

The reference standard 100 may include a plurality of alignment marks 114 positioned on the outer inspection surface 110, adjacent to the first end 104. The plurality of alignment marks 114 may be used to verify positioning or alignment of a probe relative to the reference standard 100. Additionally, the plurality of alignment marks 114 may assist in aligning the probe within the intended inspection arc and about a central axis of the elongated tool 102.

The reference standard 100 may also include first inset parallel surfaces 116, which are inset relative to the outer testing surface 112 and extend from the first end 104 towards the second end 106 of the elongated tool 102. That is, the first inset parallel surfaces 116 have a first length (L₁). The first inset parallel surfaces 116 are configured to assess horizontal linearity of an NDI system. In some examples, the reference standard 100 may also include a second inset parallel surfaces 148. The second inset parallel surfaces 148 are inset relative to the outer testing surface 112 and extend from the second end 106 towards the first end 104 of the elongated tool 102. The second inset parallel surfaces 148 have a second length (L₂). In some examples, the reference standard 100 may include both the first inset parallel surfaces 116 and the second inset parallel surfaces 148. In other examples, only one set of inset parallel surfaces may be included, such as the first inset parallel surfaces 116 or the second inset parallel surfaces 148. Either set of inset parallel surfaces can be used to assess horizontal linearity of an NDI system, depending on the orientation or setup requirements for the scanning operation. Additionally, the first inset parallel surfaces 116 and/or the second inset parallel surfaces 148 may also serve as attachment points or alignment guides when securing the reference standard 100 in place during scanning operations, to fix the reference standard 100 in place, relative to the probe.

Additionally, the reference standard 100 may include a normalization area 128. The normalization area 128 is free of known defects and extends longitudinally along only a portion of the outer testing surface 112. The normalization area 128 may be used to provide a defect-free baseline that allows for the calibration and normalization of NDI system scan data. By using a known, defect-free region, the NDI system can establish values for signal strength, alignment, and other system parameters, which may ensure accurate comparison when evaluating other features of the reference standard 100.

The reference standard 100 may also include a pair of parallel inspection lines 118 positioned within an inspection arc (e.g., a 90-degree inspection arc) defined along a circumference of the outer testing surface 112. As used herein, an inspection arc refers to a defined angular segment of the outer testing surface 112 that encompasses the features being evaluated, such as the parallel inspection lines 118. The inspection arc may vary depending on the specific requirements of the NDI system or the geometry of the components being inspected. The pair of parallel inspection lines 118 extend longitudinally along the outer testing surface 112 and are used to evaluate the arc coverage of the inspection arc during scanning operations. An angled distortion line 122 extends between and intersects the pair of parallel inspection lines 118 at an angle relative to the pair of parallel inspection lines 118. The angled distortion line 122 serves as a method to identify distortion in scan data (e.g., C-scan image) produced by the NDI system. If the angled distortion line 122 appears shifted, curved, or otherwise altered in the resulting scan data, it indicated that distortion is present, which may affect the accuracy of future inspections by the NDI system.

The reference standard 100 may further include a plurality of radial index marks 124 arranged circumferentially about and extending longitudinally along the outer testing surface 112. The plurality of radial index marks 124 are parallel to each other and equally spaced apart. The plurality of radial index marks 124 are used to verify the radial index spatial resolution of the NDI system. Additionally, the reference standard 100 may include a plurality of lateral index marks 126 arranged axially along the outer testing surface 112 and extending laterally across the outer testing surface 112. The plurality of lateral index marks 126 being parallel to each other and equally spaced apart. Similar to the plurality of radial index marks 124, the lateral index marks 126 are used to verify the axial index spatial resolution of the NDI system.

The reference standard 100 may include a plurality of inspection holes 130 formed in the outer testing surface 112. In some examples, the plurality of inspection holes 130 includes at least one proximal hole 132, at least one mid hole 134, and at least one distal hole 136, with their positions defined relative to the first end 104. The plurality of inspection holes 130 may vary in depths to assess defect detection capabilities of the NDI system at different locations along the inspection arc of the outer testing surface 112. Additionally, in some examples, a distribution of the plurality of inspection holes 130 across the inspection arc may provide a means to verify the NDI system’s ability to maintain consistent arc coverage and detect anomalies throughout a scanning operation. That is, similar to the pair of parallel inspection lines 118, the plurality of inspection holes 130 may serve as a visual indicator of arc coverage in scan data.

In some examples, the reference standard 100 may also include a ramped area 144 formed in the outer testing surface 112. The ramped area 144 has a radius of curvature that transitions evenly and consistently from a first radius to a second radius over a predetermined span (S). The ramped area 144 is configured to evaluate the alignment of a probe relative to the reference standard 100. A runout area 146 may be formed in the outer testing surface 112 contiguous with the ramped area 144. The runout area 146 provides additional length to aid in splash mitigation when necessary, ensuring that any material generated during scanning operations is controlled or redirected to prevent interference with the inspection process.

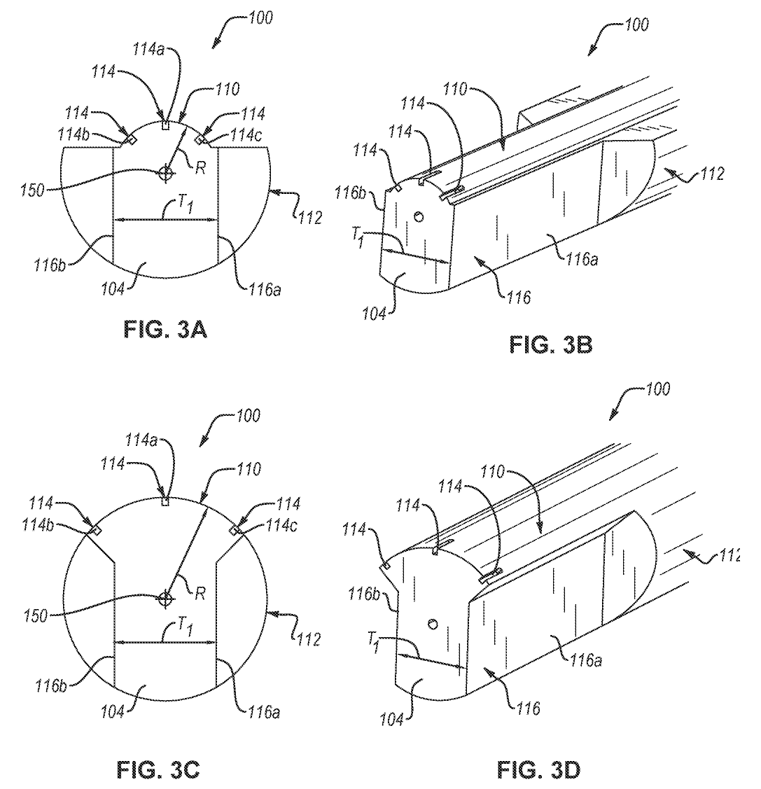

FIGS. 3 through 7 illustrate specific details of the individual features that may be incorporated into the reference standard 100, as shown in FIGS. 1A-2B. Referring to FIGS. 3A to 3D, the plurality of alignment marks 114 are shown positioned on the outer inspection surface 110, adjacent to the first end 104 of the elongated tool 102. Note, FIGS. 3A and 3B correspond to the reference standard 100 illustrated in FIGS. 1A and 1B and FIGS. 3C and 3D correspond to the reference standard 100 illustrated in FIGS. 2A and 2B. The plurality of alignment marks may include any number of alignment marks, which are used to verify the positioning or alignment of a probe relative to the reference standard 100 during scanning operations. The plurality of alignment marks 114 are distributed along the circumference of the outer inspection surface 110. In some examples, the plurality of alignment marks 114 are recessed features within the outer inspection surface 110.

In some examples, the plurality of alignment marks 114 includes three alignment marks. For example, a first alignment mark 114A may be positioned at a central reference location, positioned directly above a central axis 150 of the elongated tool 102, when the reference standard 100 is oriented horizontally. This location serves as a primary geometric reference for positioning the plurality of alignment marks 114 and corresponds to the highest point of the outer testing surface 112, relative to the central axis 150. A second alignment mark 114B may be positioned at an angle of -45 degrees relative to the first alignment mark 114A along a circumference of the outer inspection surface 110, and a third alignment mark 114 C may be positioned at an angle of +45 degrees relative to the first alignment mark 114A along a circumference of the outer inspection surface 110. Together, the three alignment marks form a 90-degree arc, with each mark separated by 45 degrees. This configuration may be used to align the probes (e.g. one transmitter probe and one receiver probe) and set the angular range for TTU scanning operations, ensuring the probes are properly oriented to cover an inspection arc and maintain accurate signal transmission and reception. In other examples, the plurality of alignment marks 114 may include more than three alignment marks. The angular distribution of the plurality of alignment marks 114 may correspond to an inspection arc of the outer testing surface 112. For example, the plurality of alignment marks 114 may be positioned within a 90-degree segment of the circumference of the outer inspection surface 110, ensuring alignment with the intended scanning area of an NDI system.

The first inset parallel surfaces 116 are defined by a first inset surface 116A and a second inset surface 116B. The first inset surface 116A is spaced apart from the second inset surface 116B by a thickness (T₁). That is, the thickness (T₁) defines the spacing between the parallel surfaces, which are arranged symmetrically on opposing sides of the central axis 150 of the elongated tool 102. The first inset parallel surfaces 116 are configured to assess horizontal linearity during scanning operations by providing a controlled and consistent profile for alignment and evaluation of the NDI system. In some examples, the thickness (T₁) is equal to the baseline radius of the outer testing surface 112. In other examples, the thickness (T₁) is greater or less than the baseline radius of the outer testing surface 112. For example, in both variations of the reference standard 100, the thickness (T₁) may be 1 inch.

In some examples, the reference standard 100 may further include second inset parallel surfaces 148 located at the second end 106 of the elongated tool 102 (see, i.e., FIG. 1A-2B). Similar to the first inset parallel surfaces 116, the second inset parallel surfaces 148 are defined by a pair of opposing surfaces spaced apart by a second thickness (T₂). In some examples, the second thickness (T₂) is equal to the first thickness (T₁), providing a uniform configuration at both ends of the reference standard 100. In other examples, the second thickness (T₂) differs from the first thickness (T₁). Both the first inset parallel surfaces 116 and the second inset parallel surfaces 148 may be used interchangeably to assess horizontal linearity. Additionally, or alternatively, the first inset parallel surfaces 116 and the second inset parallel surfaces 148 may be used to position the reference standard 100 relative to an NDI system during a scanning operation, such as through undermounting fixturing.

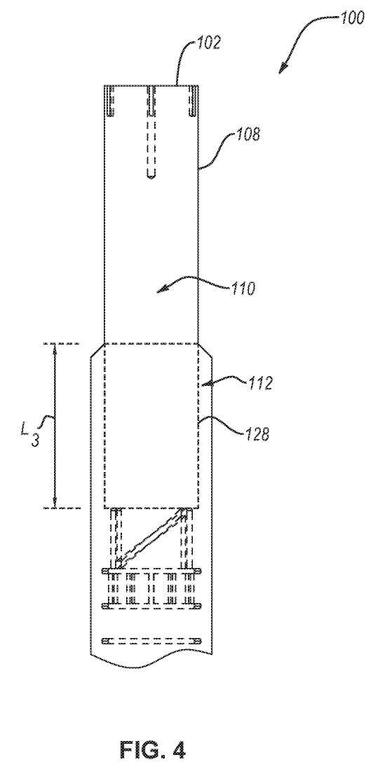

Referring to FIG. 4, the normalization area 128 is shown, as illustrated by the dotted line. The normalization area 128 is positioned adjacent to the first inset parallel surfaces 116 but could be located anywhere along the length (L_{T}) of the elongated tool 102 having a defect-free area. This area serves as a baseline for calibration, allowing the NDI system to establish reference parameters for evaluating other features of the reference standard 100. Specifically, the normalization area 128 may be used for normalization, establishing a baseline region of interest (ROI), and detecting any dead elements within the probe of the NDI system. By utilizing a known, defect-free region, the normalization area 128 ensures the accuracy and reliability of scan data during future inspection processes. The normalization area 128 extends longitudinally along a portion of the outer testing surface 112 at a length of (L₃). In some examples, the length (L₃) may range from 2 inches to 6 inches, depending on the calibration needs of the NDI system. A longer normalization area may provide greater stability during calibration, while shorter lengths may be used in compact designs or specific inspection applications. In other examples, the length (L₃) may be 2.5 inches.

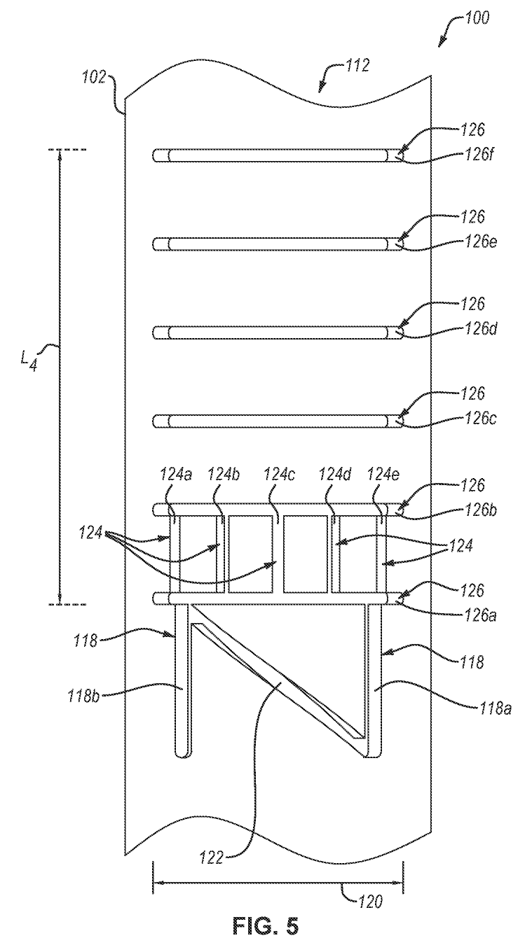

Referring to FIG. 5, the pair of parallel inspection lines 118, the angled distortion line 122, the plurality of radial index marks 124, and the plurality of lateral index marks 126 are shown along a portion of the outer testing surface 112 of the elongated tool 102. Each of these features is recessed within the outer testing surface 112. In some cases, each one of the recessed features are recessed at a consistent depth to provide a consistent profile for interaction with the probe of the NDI system during scanning operations.

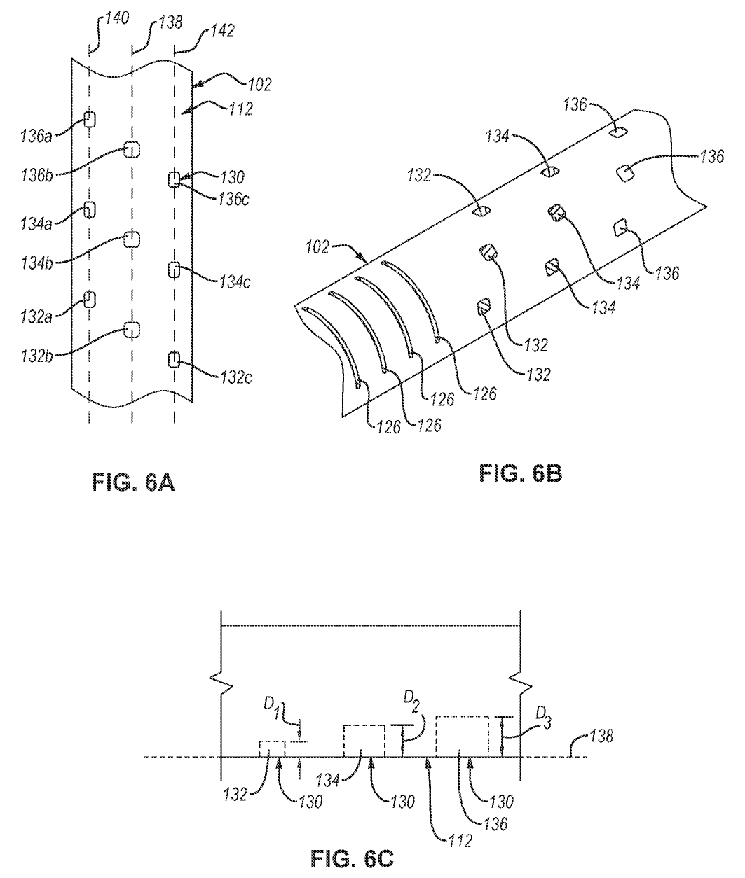

The pair of parallel inspection lines 118 are positioned along the outer testing surface 112, and include a first parallel inspection line 118A and a second parallel inspection line 118B. These lines are designed to provide an indication of arc coverage during scanning operations, which may also be assessed through the plurality of inspection holes 130 as explained below in reference to FIG. 6A. The pair of parallel inspection lines 118 extend longitudinally along the outer testing surface 112 and have a uniform length and width. In some examples, the pair of parallel inspection lines 118 may have a uniform width of 0.120 inches. The pair of parallel inspection lines 118 are positioned within the inspection arc 120, such as a 90-degree inspection arc. In some examples, each one of the pair of parallel inspection lines 118 is offset by 0.040 inches in arc length from an edge of the inspection arc 120. This placement ensures that the inspection lines are closely aligned with the edges of the inspection arc 120, which enables a user to visually verify whether a scan adequately covers the intended inspection arc. For instance, a gap between an edge of the inspection arc 120 and the corresponding one of the pair of parallel inspection lines 118 in the scan data indicates that the scanning arc coverage is sufficient. Conversely, the absence of such a gap may indicate insufficient arc coverage, necessitating further adjustments to the probe alignment or scanning parameters. The precise positioning and consistent width of the pair of parallel inspection lines 118 ensure that the NDI system provides reliable and repeatable results when evaluating arc coverage.

The angled distortion line 122 is positioned along the outer testing surface 112 and intersects the pair of parallel inspection lines 118 at an angle. Specifically, the angled distortion line 122 serves as a reference for identifying any distortion artifacts that may occur during scanning operations. If the angled distortion line 122 appears shifted, curved, or otherwise altered in the resulting scan data, this indicates that distortion is present, which may affect the accuracy of the NDI system. The angled distortion line 122 extends longitudinally along the outer testing surface 112 at a non-parallel orientation relative to the pair of parallel inspection lines 118. In some examples, the angled distortion line 122 is angled at approximately 50 degrees relative to the pair of parallel inspection lines 118. Additionally, the angled distortion line 122 may have a uniform width. For instance, in some examples, the angled distortion line 122 may have a width of approximately 0.125 inches. The dimensions and angular relationships are exemplary and may vary depending on the specific design requirements of the reference standard 100. When correctly captured in the scan data, the angled distortion line 122 maintains its original straight-line profile. Any visual deviation, such as curvature or breaks, may indicate misalignment, signal distortion, or scanning issues, prompting adjustments to the NDI system or scanning parameters. Accordingly, the angled distortion line 122 may be used to detect and mitigate potential source of distortion effectively.

The plurality of radial index marks 124 are positioned circumferentially along a portion of the outer testing surface 112 and extend longitudinally along the outer testing surface 112. These marks are used to assess the NDI system’s ability to accurately measure and interpret spatial relationship across the radial direction of the outer inspection surface 110. Specifically, the plurality of radial index marks 124 provides a consistent and repeatable pattern that allows for precise measurement of pixel spacing and alignment when rastering along the inspection arc 120. The plurality of radial index marks 124 are parallel to each other and equally spaced apart along the inspection arc 120. In some examples, the plurality of radial index marks 124 may be positioned between two adjacent ones of the plurality of lateral index marks 126, such as a first lateral mark 126A and a second lateral mark 126B. In other examples, the plurality of radial index marks 124 may be separated from the plurality of lateral index marks 126. The plurality of radial index marks 124 may have uniform dimensions. For instance, each one of the plurality of radial index marks 124 may be 0.080 inches wide, with an arc spacing of 0.25 inches between adjacent marks. This arrangement forms a radial ridge pattern that is used to measure the number of pixels between marks and calculate an average spacing across the spaces between marks. Such calculations enable verification of the radial encoding index when rastering in a direction along the plurality of radial index marks 124.

In some examples, the plurality of radial index marks 124 includes at least four radial index marks, forming three spaces between adjacent radial index marks. In other examples, the plurality of radial index marks 124 includes five radial index marks, forming four spaces between adjacent radial index marks. For example, a first radial mark 124A, a second radial mark 124B, a third radial mark 124C, a fourth radial mark 124D, and a fifth radial mark 124E. During rastering operations, the NDI system may measure the pixel spacing between these spaces, with the measurements averaged and compared to the expected values. Radius corrections may be applied as needed to ensure accuracy. Any deviations from the expected values may indicate issues with the radial encoding or alignment of the NDI system, which can be addressed to improve overall performance.

The plurality of lateral index marks 126 are positioned axially along a length (L4) of the outer testing surface 112 and extend laterally across the outer testing surface 112. These marks are configured to assess the NDI system’s ability to accurately measure and interpret spatial relationships along the axial direction of the elongated tool 102. Specifically, the plurality of lateral index marks 126 provides a consistent and repeatable pattern that enables precise measurement of pixel spacing and alignment when rastering along the axial direction of the outer inspection surface 110. The plurality of lateral index marks 126 are parallel to each other and equally spaced apart. In some examples, the plurality of lateral index marks 126 may have uniform dimensions. For example, each one of the plurality of lateral index marks 126 may be 0.08 inches wide, with an axial spacing of 0.5 inches between adjacent marks. This arrangement forms an axial ridge pattern that is used to measure the number of pixels between marks and calculate an average spacing across the spaces between adjacent marks. These calculations enable verification of the axial encoding index when rastering along the plurality of lateral index marks 126.

In some examples, the plurality of lateral index marks 126 includes at least four lateral index marks, forming three spaces between adjacent lateral index marks. In other examples, the plurality of lateral index marks 126 includes six lateral index marks, forming five spaces between adjacent lateral index marks. For example, the first lateral mark 126A, the second lateral mark 126B, a third lateral mark 126C, a fourth lateral mark 126D, a fifth lateral mark 126E, and a sixth lateral mark 126F. During rastering operations, the NDI system may measure the pixel spacing between these spaces, with the measurements averaged and compared to the expected values. Corrections may be applied as needed to ensure accuracy. Any deviations from the expected values may indicate issues with the axial encoding or alignment of the NDI system, which can then be addressed to improve overall performance.

Referring to FIGS. 6A-6C, the plurality of inspection holes 130 are positioned along the outer testing surface 112 of the elongated tool 102. The plurality of inspection holes 130 are designed to evaluate the detect detection capability of the NDI system across the inspection arc 120, and may provide another method for assessing arc coverage during scanning operations. Each hole of the plurality of inspection holes 130 has a uniform geometric configuration. For example, each hole may be a flat-bottomed, back-drilled holes with rounded square corners. Additionally, in some examples, the lateral dimensions of each hole, such as a length and a width, may be consistent dimensions, such as 0.25 inches by 0.25 inches. However, the depth of at least one hole of the plurality of inspection holes is different from others of the plurality of inspection holes 130.

In some examples, the plurality of inspection holes 130 includes at least one proximal hole 132, at least one mid hole 134, and at least one distal hole 136. The proximal holes 132, the mid holes 134, and the distal holes 136 are distributed at varying depths relative to the outer testing surface 112. Specifically, the at least one proximal hole 132 has a first depth (D1), the at least one mid hole 134 has a second depth (D2), and the at least one distal hole 136 has a third depth (D3). The second depth (D2) is greater than the first depth (D1), and the third depth (D3) is greater than the second depth (D2), providing a gradation of depths to test the NDI system’s sensitivity and resolution at different penetration levels. In some examples, the first depth (D1) of the proximal hole 132 may be at least 0.01 inches, the third depth (D3) of the distal hole 136 may be at most 1.0 inches, and the second depth (D2) of the mid hole 134 is intermediate, being greater than the first depth (D1) but less than the third depth (D3).

The plurality of inspection holes 130 may be organized in a consistent pattern across parallel planes relative to the central axis 150 of the elongated tool 102. For example, at least three proximal holes 132, including a first proximal hole 132A positioned along a first plane 140, a second proximal hole 132B positioned along a second plane 138, parallel to the first plane 140, and a third proximal hole 132C positioned along a third plane 142, parallel to the first plane 140 and second plane 138. The second plane 138 is interposed between the first plane 140 and the third plane 142. In some examples, the first plane 140 is positioned tangential to the outer testing surface 112 on one side of the inspection arc 120, while the third plane 142 is tangential to the opposing side of the inspection arc 120. The second plane 138 is interposed between the first plane 140 and the third plane 142, aligned directly above the central axis 150 of the elongated tool 102. Similarly, the mid holes 134 (i.e., first mid hole 134A, second mid hole 134B, and third mid hole 134C) and the distal holes 136 (i.e., first distal hole 136A, second distal hole 136B, and third distal hole 136C) are aligned along the first plane 140, the second plane 138, and the third plane 142, forming a repeating pattern across the inspection arc 120. Accordingly, as shown in FIG. 6C, in some examples, each of the plurality of inspection holes 130 formed along a plane, such as the second plane 138, has a different depth. By measuring the scan data over the plurality of inspection holes 130, the NDI system can verify the adequacy of detecting defects and in some cases, adequacy of arc coverage.

While the plurality of inspection holes 130 are described as being organized in a consistent pattern across parallel planes relative to the central axis 150, the layout of the inspection holes is not limited to this arrangement. In alternative configurations, the plurality of inspection holes 130 may be distributed in any pattern along the elongated tool 102, such as a spiral arrangement, staggered rows, or random distribution.

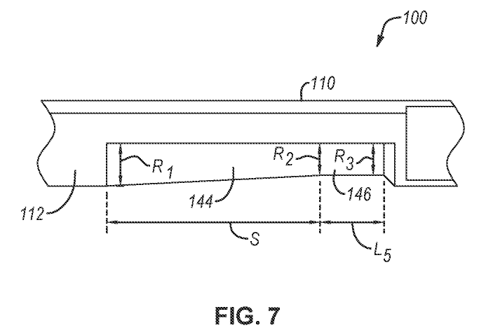

Referring to FIG. 7, the ramped area 144 is shown along the outer testing surface 112 of the elongated tool 102. The ramped area 144 transitions between different radii, providing a controlled geometry for evaluating the performance of the NDI system when scanning across surfaces with varying curvatures. The transition is defined by a first radius (R1) and a second radius (R2), with the second radius (R2) being smaller than the first radius (R1). The ramped area 144 extends over a predetermined span (S) along the length (L_{T}) of the elongated tool 102. In some examples, the predetermined span (S) may be approximately 5 inches, though other lengths may be used depending on the application. The first radius (R1) may correspond to the baseline radius of the outer testing surface 112. For example, the first radius (R1) may be 1 inch, transitioning to the second radius (R2) which may be 0.75 inches, thereby creating a gradual slope for testing probe adaptability and resolution. The ramped area 144 is configured to evaluate the alignment of a probe relative to the reference standard 100. Specifically, during scanning operations, the ramped area 144 ensures that scans performed in opposing directions produce consistent results if the probe is properly aligned perpendicular to the outer inspection surface 110. That is, if the probe is misaligned (e.g., at an incorrect angle relative to the ramped area), the resulting scans will exhibit differences, such as shifts or inconsistencies, indicating alignment issues.

The runout area 146 is formed along the outer testing surface 112, contiguous with the ramped area 144 of the elongated tool 102. The runout area 146 extends beyond the end of the ramped area 144 and is characterized by a constant radius (R3), which is equal to the second radius (R2) of the ramped area 144. The continuity ensures a smooth transition from the ramped area 144 into the runout area 146, maintaining uniformity in the geometry of the outer testing surface 112. The runout area provides additional length to aid in controlling any material generated during scanning operations, such as liquid or debris, such that any material does not interfere with the inspection process. For example, the runout area 146 may mitigate splash effects by redirection or controlling material flow along its surface. The runout area has a length (L₅). In some examples, the length (L₅) is less than the predetermined span (S) of the ramped area 144. For example, the length (L₅) may be 1.5 inches. The combination of the ramped area 144 and the runout area 146 create a controlled testing environment during scanning operations.

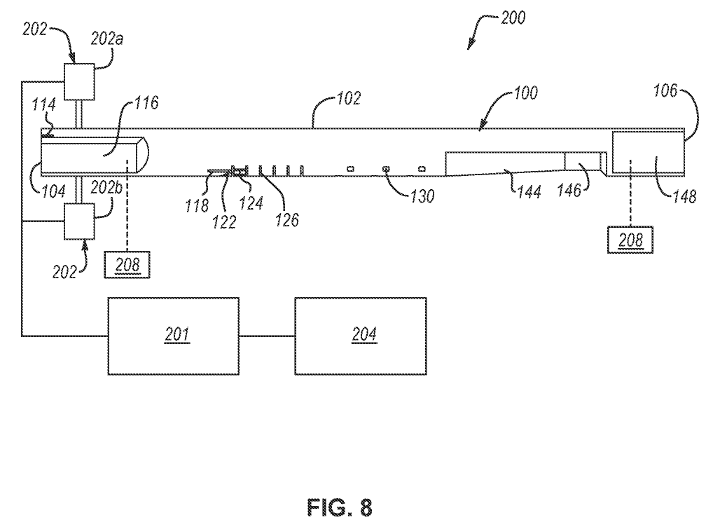

As shown in FIG. 8, is one example of an NDI system for evaluating components. The NDI system includes an NDI device 201 configured to interact with the reference standard 100 during scanning operations. The NDI device 201 includes a probe 202 and a control system 204. The probe 202 interacts with the reference standard 100 during a scanning operation and is configured to generate and receive signals, such as ultrasonic signals. The term “interacts” here broadly refers to the functional engagement between the probe 202 and the reference standard 100, which may involve direct physical contact or indirect engagement through a coupling medium. In some examples, the probe 202 may include a contact transducer configured to maintain direct physical contact with the outer inspection surface 110 of the reference standard 100. Such probes typically utilize a coupled material, like a gel, to ensure efficient transmission of ultrasonic signals into the reference standard 100. In other examples, the probe 202 may be a through-transmission ultrasound (TTU) probe, which operates without direct contact. Instead, the TTU probe uses a water column or a water spray as a coupling medium to transmit ultrasonic signals to and from the reference standard 100. The water serves as a conduit for the ultrasonic waves, which allows for precise measurements even when the probe 202 is positioned at a slight distance from a surface of the reference standard 100.

Additionally, the probe 202 may include different configurations, such as phased array probes or immersion probes. A phased array probe uses multiple transducer elements that can be electronically steered to cover a larger area of focus the ultrasonic waves at specific points on the reference standard 100. The varying probe configurations ensure that the NDI system 200 can be adapted to different inspection requirements and surface geometries of the reference standard 100.

The probe 202 is generally configured to interact with the outer inspection surface 110 of the reference standard 100 in a single-probe NDI system. This is achieved indirectly by transmitting and receiving signals, such as ultrasonic waves, that propagate through the reference standard 100 to assess features on the outer inspection surface 110. In a multi-probe NDI system, one probe, such as a first probe 202A, may interact directly with the outer inspection surface 110 and another probe, such as a second probe 202B, may interact directly with the outer testing surface 112.

The control system 204 is operatively connected to the probe 202 and is configured to analyze data collected during a scanning operation between the probe 202 and the reference standard 100. That is, the control system 204 analyzes the signal generated by the probe 202 in relation to the known features of the reference standard 100, such as the plurality of alignment marks 114, the first inset parallel surfaces 116, etc. This analysis allows the NDI system 200 to assess key performance metrics, such as sensitivity, resolution, and spatial accuracy. The connection between the control system 204 and the probe 202 may vary depending on the configuration of the NDI system 200.

In some examples, the control system 204 may be integrated into the NDI device 201, forming a single unit. In other examples, the control system 204 may be a separate processing unit, operatively linked to the probe 202 and NDI device 201 through a wired connection or wirelessly via a communication network.

The reference standard 100 may be positioned relative to the NDI system 200 to ensure accurate and consistent scanning operations. In some examples, the first inset parallel surfaces 116 and the second inset parallel surfaces 148 are configured to be engaged by a clamping device 208 that secures the reference standard 100 during a scanning operation, to minimize movement or misalignment of the reference standard 100 during scanning. The clamping device 208 can include various configurations and mechanisms depending on the specific application and setup. For example, the clamping device 208 may include a mechanical vise or gripping arms that engage the inset parallel surfaces to hold the reference standard 100 in place. In other examples, the clamping device 208 may include a magnetic or vacuum-based fixture. Additionally, in some configurations, the clamping device 208 may be designed as an undermount fixturing mechanism. Such a device may support the reference standard 100 from below, engaging the inset parallel surfaces.

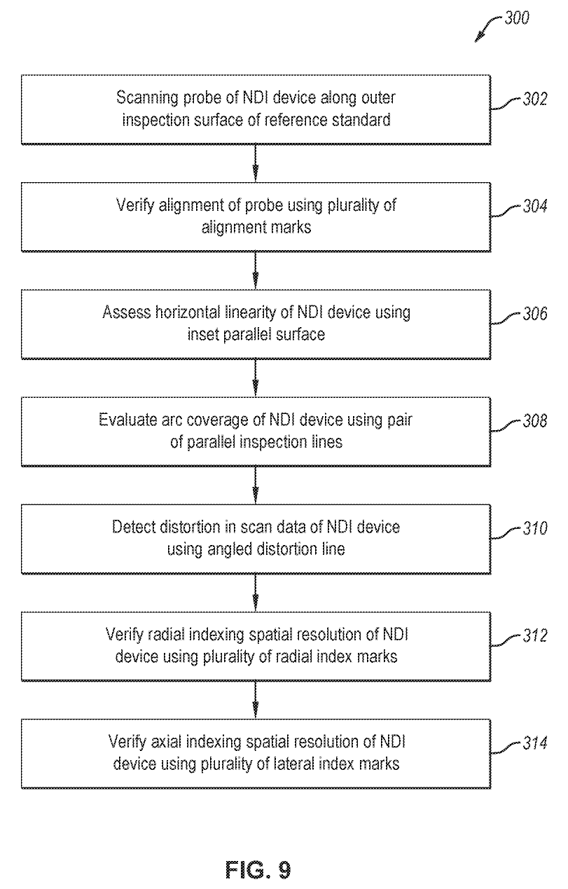

Referring to FIG. 9, and according to one example, a method 300 for evaluating an NDI system using a reference standard 100 is shown. The method 300 includes (block 302) scanning the probe 202 of the NDI device 201 along the outer inspection surface 110 of the elongated tool 102. This allows the NDI device to capture data relative to the features of the reference standard 100. The method 300 also includes (block 304) verifying alignment of the probe 202 using the plurality of alignment marks 114 positioned adjacent to the first end 104 of the elongated tool 102. The plurality of alignment marks 114 provide a visual and/or signal-based reference to confirm that the probe 202 is properly positioned relative to the reference standard 100 before proceeding with any further inspection.

The method 300 further includes (block 306), assessing horizontal linearity of the NDI device using first inset parallel surface 116. This ensures that the NDI system can accurately measure and interpret spatial relationship along the horizontal plane. Additionally, the method 300 includes (block 308) evaluating arc coverage of the NDI device using the pair of parallel inspection lines 118 extending longitudinally along the outer testing surface 112 and positioned within the inspection arc defined along the circumference of the outer testing surface 112. By scanning the pair of parallel inspection lines 118, the method 300 confirms whether the NDI device 201 adequately covers the intended arc during inspection.

The method 300 also includes (block 310) detecting distortion in scan data of the NDI device using the angled distortion line extending between and intersecting the pair of parallel inspection lines 118 at an angle relative to the pair of parallel inspection lines 118. The angled distortion line 122 serves as a reference for identifying any shifting, curving, or other distortions in the scan data, which could indicate alignment or system calibration issues. The method 300 further includes (block 312) verifying radial indexing spatial resolution of the NDI device using the plurality of radial index marks 124 arranged circumferentially about and extending longitudinally along the outer testing surface 112. By measuring the pixel spacing between adjacent radial index marks, the NDI device can verify the accuracy of its radial spatial resolution. The method additionally includes (block 314) verifying axial index spatial resolution of the NDI device using the plurality of lateral index marks arranged axially along the outer testing surface 112 and extending laterally across the outer testing surface 112. By measuring the pixel spacing between adjacent lateral index marks, the NDI device can verify the accuracy of its axial spatial resolution.

The steps of the method 300 can be performed in any order, depending on the specific requirements of the evaluation process. Additionally, the reference standard 100 may include features beyond those described, allowing for further testing or customization based on the needs of the NDI system. In the event that the NDI device identifies an inconsistency or deviation from expected performance, adjustments can be made to the NDI device or its parameters, such as recalibration, realignment, or modification of scanning settings. Once adjustments are completed, the method 300 can be repeated to confirm that the NDI device meets the desired performance criteria.

In the above description, certain terms may be used such as "up," "down," "upper," "lower," "horizontal," "vertical," "left," "right," “over,” “under” and the like. These terms are used, where applicable, to provide some clarity of description when dealing with relative relationships. But, these terms are not intended to imply absolute relationships, positions, and/or orientations. For example, with respect to an object, an "upper" surface can become a "lower" surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

The term “about” or “substantially” in some embodiments, is defined to mean within +/-5% of a given value, however in additional embodiments any disclosure of “about” may be further narrowed and claimed to mean within +/- 4% of a given value, within +/- 3% of a given value, within +/- 2% of a given value, within +/- 1% of a given value, or the exact given value. Further, when at least two values of a variable are disclosed, such disclosure is specifically intended to include the range between the two values regardless of whether they are disclosed with respect to separate embodiments or examples, and specifically intended to include the range of at least the smaller of the two values and/or no more than the larger of the two values. Additionally, when at least three values of a variable are disclosed, such disclosure is specifically intended to include the range between any two of the values regardless of whether they are disclosed with respect to separate embodiments or examples, and specifically intended to include the range of at least the A value and/or no more than the B value, where A may be any of the disclosed values other than the largest disclosed value, and B may be any of the disclosed values other than the smallest disclosed value.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms "first," "second," etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. A reference standard for evaluation of a non-destructive inspection (NDI) device, comprising:
an elongated tool comprising a first end, a second end, and an outer surface extending between the first end and the second end, wherein the outer surface comprises:
an outer inspection surface defining a constant radius; and
an outer testing surface forming a remainder of the outer surface contiguous with the outer inspection surface;
a plurality of alignment marks positioned on the outer inspection surface adjacent to the first end of the elongated tool;
first inset parallel surfaces inset relative to the outer testing surface, the first inset parallel surfaces extending from the first end towards the second end of the elongated tool and having a first length;
a pair of parallel inspection lines extending longitudinally along the outer testing surface and positioned within an inspection arc defined along a circumference of the outer testing surface;
an angled distortion line extending between and intersecting the pair of parallel inspection lines at an angle relative to the pair of parallel inspection lines;
a plurality of radial index marks arranged circumferentially about and extending longitudinally along the outer testing surface, the plurality of radial index marks being parallel to each other and equally spaced apart; and
a plurality of lateral index marks arranged axially along the outer testing surface and extending laterally across the outer testing surface, the plurality of lateral index marks being parallel to each other and equally spaced apart.

2. The reference standard of claim 1, further comprising second inset parallel surfaces inset relative to the outer testing surface, the second inset parallel surfaces extending from the second end towards the first end of the elongated tool along a second length.

3. The reference standard of claim 1, wherein the outer testing surface comprises a normalization area that is free of known defects and extends longitudinally along only a portion of the outer testing surface.

4. The reference standard of claim 1, further comprising a plurality of inspection holes formed in the outer testing surface, the plurality of inspection holes including at least one proximal hole, at least one mid hole, and at least one distal hole, wherein:
the at least one proximal hole has a first depth relative to the outer testing surface;
the at least one mid hole has a second depth relative to the outer testing surface;
the second depth is greater than the first depth;
the at least one distal hole has a third depth relative to the outer testing surface; and
the third depth is greater than the second depth.

5. The reference standard of claim 4, wherein:
the first depth of the at least one proximal hole is at least 0.010 inches;
the third depth of the at least one distal hole is at most 1.0 inches; and
the second depth of the at least one mid hole is more than the first depth and less than the third depth.

6. The reference standard of claim 4, wherein:
the plurality of inspection holes includes at least three proximal holes, at least three mid holes, and at least three distal holes;
the at least three proximal holes include a first proximal hole positioned along a first plane that is parallel to a central axis of the elongated tool, a second proximal hole positioned along a second plane parallel to the first plane, and a third proximal hole positioned along a third plane parallel to the first plane, the second plane interposed between the first plane and the third plane;
the at least three mid holes include a first mid hole positioned along the first plane, a second mid hole positioned along the second plane, and a third mid hole positioned along the third plane; and
the at least three distal holes include a first distal hole positioned along the first plane, a second distal hole positioned along the second plane, and a third distal hole positioned along the third plane.

7. The reference standard of claim 1, further comprising a ramped area formed in the outer testing surface, the ramped area having a radius of curvature that transitions from a first radius to a second radius over a predetermined span along a length of the elongated tool.

8. The reference standard of claim 7, further comprising a runout area formed in the outer testing surface contiguous with the ramped area, the runout area having a constant radius equal to the second radius of the ramped area and extending along a length of the outer testing surface.

9. The reference standard of claim 1, wherein the plurality of alignment marks comprises:
a first alignment mark positioned at a central reference location;
a second alignment mark positioned at an angle of -45 degrees relative to the first alignment mark along a circumference of the outer inspection surface; and
a third alignment mark positioned at an angle of +45 degrees relative to the first alignment mark along a circumference of the outer inspection surface.

10. The reference standard of claim 1, wherein the plurality of radial index marks includes at least four radial index marks.

11. The reference standard of claim 1, wherein the plurality of lateral index marks includes at least four lateral index marks.

12. The reference standard of claim 1, wherein the constant radius of the outer inspection surface is between, and inclusive of, 0.25 inches and 4.0 inches.

13. The reference standard of claim 1, wherein the elongated tool is made of a homogeneous material.

14. The reference standard of claim 1, wherein the elongated tool is made of an acrylic material.

15. A non-destructive inspection (NDI) system for evaluating components, the system comprising:
an NDI device comprising:
a probe configured to interact with a reference standard; and
a control system operatively connected to the probe, the control system configured to analyze data collected during a scanning operation between the probe and the reference standard; and
the reference standard comprising:
an elongated tool comprising a first end, a second end, and an outer surface extending between the first end and the second end, wherein the outer surface comprises:
an outer inspection surface defining a constant radius; and
an outer testing surface forming a remainder of the outer surface contiguous with the outer inspection surface;
a plurality of alignment marks positioned on the outer inspection surface adjacent to the first end of the elongated tool;
first inset parallel surfaces inset relative to the outer testing surface, the first inset parallel surfaces extending from the first end towards the second end of the elongated tool and having a first length;
a pair of parallel inspection lines extending longitudinally along the outer testing surface and positioned within an inspection arc defined along a circumference of the outer testing surface;
an angled distortion line extending between and intersecting the pair of parallel inspection lines at an angle relative to the pair of parallel inspection lines;
a plurality of radial index marks arranged circumferentially about and extending longitudinally along the outer testing surface, the plurality of radial index marks being parallel to each other and equally spaced apart; and
a plurality of lateral index marks arranged axially along the outer testing surface and extending laterally across the outer testing surface, the plurality of lateral index marks being parallel to each other and equally spaced apart.

16. A method for evaluating a non-destructive inspection (NDI) system using a reference standard, the method comprising:
scanning a probe of an NDI device along an outer inspection surface of an elongated tool;
verifying alignment of the probe using a plurality of alignment marks positioned adjacent to a first end of the elongated tool;
assessing horizontal linearity of the NDI device using first inset parallel surfaces, inset relative to an outer testing surface of the elongated tool;
evaluating arc coverage of the NDI device using a pair of parallel inspection lines extending longitudinally along the outer testing surface and positioned within an inspection arc defined along a circumference of the outer testing surface;
detecting distortion in scan data of the NDI device using an angled distortion line extending between and intersecting the pair of parallel inspection lines at an angle relative to the pair of parallel inspection lines;
verifying radial indexing spatial resolution of the NDI device using a plurality of radial index marks arranged circumferentially about and extending longitudinally along the outer testing surface; and
verifying axial index spatial resolution of the NDI device using a plurality of lateral index marks arranged axially along the outer testing surface and extending laterally across the outer testing surface.

17. The method of claim 16, further comprising verifying array normalization of the NDI device and detecting dead elements within the probe using a normalization area that is free of known defects and extends longitudinally along only a portion of the outer testing surface.

18. The method of claim 16, further comprising verifying a capacity of the NDI device to detect and determine a size of defects using a plurality of inspection holes formed in the outer testing surface of the elongated tool, wherein each one of the plurality of inspection holes has a specified depth relative to the outer testing surface.

19. The method of claim 16, further comprising verifying alignment of the NDI device relative to the outer testing surface of the elongated tool using a ramped area formed in the outer testing surface of the elongated tool, the ramped area transitioning from a first radius to a second radius over a predetermined span along a length of the elongated tool.

20. The method of claim 16, further comprising fixing the reference standard relative to the probe during a scanning operation by engaging the first inset parallel surfaces and second inset parallel surfaces, positioned within the outer testing surface of the elongated tool, using a clamping device.
